(19) United States
(12) Patent Application Publication
(10) Pub. No.: US 2025/0272583 A1
(43) Pub. Date: Aug. 28, 2025

(54) INTELLIGENT METHOD TO OPTIMIZE STRUCTURED RULES

(71) Applicant: INTERNATIONAL BUSINESS MACHINES CORPORATION, ARMONK, NY (US)

(72) Inventors: Jin Wang, Xi'an (CN); Lei Gao, Xi'an (CN); A Peng Zhang, Xi'an (CN); Kai Li, Xi'an (CN); Jia Xing Tang, Xi'an (CN); Xin Feng Zhu, Xi'an (CN)

(21) Appl. No.: 18/590,873

(22) Filed: Feb. 28, 2024

(51) Int. Cl. G06N 5/025

(52) U.S. Cl. CPC G06N 5/025

(57) ABSTRACT

A computer-implemented method and device to optimize structured rules in data processing. The method includes filtering and selecting one rule from a plurality of rules. An expression of the one rule is vectorized with different dimensions. A cluster model of rules is built from at least some of the plurality of rules having a vector distance that is replaced by a specific vector distance. The building of the cluster model of rules is based on identifying a tree-similarity related distance of some of the plurality of rules from the selected one rule.

### BACKGROUND

### Technical Field

The present disclosure is generally related to rules used in data science, and more particularly, to the removal of redundant rules in data and information processing.

### Description of the Related Art

Data processing is used to extract information from raw material, and information processing may change the form of information to provide more meaning from the information. In both cases, rules that number in the thousands are used to find useful information from data. Data rules are used to define the logic to perform data analysis. More particularly, the number of rules used in the processing of big data can create inefficiencies in computer operations.

### SUMMARY

According to an embodiment, a computer-implemented method and device to optimize structured rules in data processing includes filtering and selecting one rule from a plurality of rules. An expression of the one rule is vectorized with different dimensions. A cluster model of rules is built from at least some of the plurality of rules having a vector distance that is replaced by a specific vector distance. The building of the cluster model of rules is based on identifying a tree-similarity related distance of some of the plurality of rules from the selected one rule.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is a screenshot of a rule editor application, consistent with an illustrative embodiment.

FIG. 2 illustrates a tree structure in which an expression is vectorized based on one rule, consistent with an illustrative embodiment.

FIG. 3 illustrates a tree structure with connected weights, consistent with an illustrative embodiment.

FIG. 4 is a flowchart illustrating a process for optimizing rules consistent with an illustrated embodiment.

FIG. 5 illustrates a block diagram of a particularly configured computing environment for optimizing rules, consistent with an illustrative embodiment.

### DETAILED DESCRIPTION

In the following detailed description, numerous specific details are set forth by way of examples to provide a thorough understanding of the relevant teachings. However, it is to be understood that the present teachings may be practiced without such details. In other instances, well-known methods, procedures, components, and/or circuitry have been described at a relatively high-level, without detail, to avoid unnecessarily obscuring aspects of the present teachings. It is also to be understood that the present disclosure is not limited to the depictions in the drawings, as there may be fewer elements or more elements than shown and described.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

As used herein, a tree data structure refers to a hierarchical structure used for the representation and organization of data. A collection of nodes is connected by edges and there is a hierarchical relationship between nodes.

As used herein, tree similarity measurement refers to a measurement based on an edit distance. The edit distance is the minimal number of select operations used to transform one tree to another tree.

As used herein, the term “rule” is not limited to a particular field, and a set of rules can be based on science, engineering, business, etc. By selecting one or some rules from all the rules in an application based on special vectorization and distance computation, processing time and processing power is saved rather than passing data records through all of the rules.

As used herein, a rule expression refers to a relationship between a set of input data values and a set of result values.

As used herein, the term vectorization refers to an optimization of an algorithm to improve execution speed. Vectorization of a rule expression improves the execution speed processing and will reduce the memory used by more efficiently modifying the rule expressions.

### Technical Advantages and Support

It is to be understood that some of the advantages of the present disclosure are provided herein below. However, a person of ordinary skill in the art will appreciate that additional advantages may exist in addition to those described herein.

In an embodiment, a computer-implemented method of optimizing structured rules in data processing includes filtering and selecting one rule from a plurality of rules. An expression of the one rule is vectorized with different dimensions. A cluster model of rules is built from at least some of the plurality of rules having a vector distance replaced by a specific vector distance. The building of the cluster model of rules is based on identifying a tree-similarity related distance of some of the plurality of rules from the selected one rule. By filtering and selecting the rules, more efficient processing is faster and uses fewer resources than analyzing data against all the rules.

In an embodiment, which may be combined with the preceding embodiment, the filtering and selecting of the one rule is performed using machine learning. Machine learning makes the process of filtering and selecting rules more efficiently applied.

In one embodiment, which can be combined with one or more preceding embodiments, the machine learning model filters and selects specific rules from the plurality of rules based on an identified purpose. Different identified purposes may mean that the filtered and selected rule is different, and the data is examined for different types of information to be extracted.

In one embodiment, which can be combined with one or more preceding embodiments, the vectorizing an expression of the one rule includes forming an and-or-not tree from the expression. The and-or-not tree provides an advantage in identifying the relationship and logic in a rule expression.

In one embodiment, which can be combined with one or more preceding embodiments, the instructions cause the processor to perform additional acts of building at least another cluster model of rules based on a different setting of the specific vector distance. In addition, when the building of the cluster model of rules includes forming more than one and-or-not tree, the specific distance is set by performing a distance calculation starting from a last layer number that is common to each and-or-not tree. There may be different types of information that is desired to be extracted from data, and the setting of the specific vector distance may be changed to extract the different types of data.

In one embodiment, which can be combined with one or more preceding embodiments, center vectors are selected according to predetermined criteria. The predetermined criteria facilitate a desired result.

In one embodiment, which can be combined with one or more preceding embodiments, the filtering and selecting center vectors of one or more cluster models of rules and combining the center vectors in different cluster models. The combining of the center vectors in different cluster models can provide for a broader extraction of information from data.

In one embodiment, which can be combined with one or more preceding embodiments, the building of the clustering model of rules is performed using a k-means clustering operation. Cluster models are used to aid in more efficiently applying machine learning, particularly in unsupervised learning, and to efficiently categorize groups of rules. K-means clustering is one of the most efficient ways to enhance the application of structured rules to data according to at least an illustrative embodiment of the present disclosure.

In one embodiment, which can be combined with one or more preceding embodiments, the building of the clustering model of rules is performed using a density-based clustering operation. Density-based clustering operations are an alternative way to create cluster models instead of k-means.

In one embodiment, which can be combined with one or more preceding embodiments, the building of the clustering model of rules is performed using a grid-based clustering operation. Grid-based clustering operations are another way to create cluster models instead of k-means clustering.

In one embodiment, which can be combined with one or more preceding embodiments, there is a building of a plurality of cluster models of rules from at least some of the plurality of rules. The plurality of clusters may be useful for processing data to extract different types of information. Each type may have its own cluster. Particularly with big data, there may be thousands of rules and multiple clusters may be used to effectively filter and select rules from a plurality of some or all the rules.

In one embodiment, which can be combined with one or more preceding embodiments, the building of at least another cluster model of rules is performed based on a different setting of the specific vector distance. The specific vector may be set to different distances for different purposes. There may be different types of information that is desired to be extracted from data, and the setting of the specific vector distance may be changed to extract the different types of data.

In one embodiment, which can be combined with one or more preceding embodiments, two or more cluster models of rules are combined. Multiple cluster models increase the efficiency in the application of filtering and selecting rules applicable to complex data.

In an embodiment, a computing device configured to optimize structured rules in data processing includes a processor, and a storage device coupled to the processor. The storage device stores instructions to cause the processor to perform acts including filtering and selecting one rule from a plurality of rules; vectorizing an expression of the one rule with different dimensions; and building a cluster model of rules from at least some of the plurality of rules having a vector distance replaced by a specific vector distance. The building of the cluster model of rules is based on identifying a tree-similarity related distance of some of the plurality of rules from the selected one rule. By filtering and selecting the rules, the data processing is faster and uses fewer resources than analyzing data against all the rules.

In an embodiment, which may be combined with the preceding embodiment, the instructions cause the processor to perform an additional act of using machine learning to perform the filtering and selecting of the rule. Machine learning makes the process of filtering and selecting rules more efficient.

In one embodiment, which can be combined with one or more preceding embodiments, the instructions cause the processor to perform an additional act of building the clustering model of rules by using a k-means clustering operation. K-means clustering is one of the most efficient ways to enhance the application of structured rules to data according to at least an illustrative embodiment of the present disclosure.

In one embodiment, which can be combined with one or more preceding embodiments, the instructions cause the processor to perform an additional act of using a density-based clustering operation. Density-based clustering is an alternative way to create cluster models instead of k-means.

In one embodiment, which can be combined with one or more preceding embodiments, the instructions cause the processor to perform an additional act comprising building a plurality of cluster models of rules from at least some of the plurality of rules. The plurality of clusters may be useful for processing data to extract different types of information. Each type may have its own cluster. Particularly with big data, there may be thousands of rules and multiple clusters may be used to effectively filter and select rules from a plurality of some or all the rules.

In one embodiment, which can be combined with one or more preceding embodiments, the instructions cause the processor to perform additional acts of filtering and selecting center vectors of one or more cluster models of rules and combining the center vectors in different cluster models. The combining of the center vectors in different cluster models may provide for different types of information to be extracted from the data.

In one embodiment, which can be combined with one or more preceding embodiments, the instructions cause the processor to perform additional act of combining two or more cluster models of rules. The combining of different cluster models may provide for a broader extraction of information from data.

### Overview

The present disclosure is generally directed to a method and an apparatus to reduce structured rules in computer operations.

One of the shortcomings in computer operations is the multitude of rules that are used to find useful information from data. There is a problem with computer operations regarding redundant rules, as different data sources may have the same or similar rules to pass data to find useful information. As the complexity of the data increases, the number of rules tends to increase. Numerous sources of data may also cause an increase in the number of rules, as each data source may have a set of rules for finding information that may have a similarity with at least some rules from other data sources. In more complex data sets such as big data, the number of redundant rules tends to increase. Computer operations become less efficient, as processing times become slower from the application of all the rules.

According to an aspect of the present disclosure, an intelligent method to optimize structured rules increases the speed of computer operations by reducing the number of rules by which data passes to find salient information. There is a desire to find a quick result by analyzing all the rules to provide one rule to be used as a basis to provide suggestions and direction for users when editing and/or adding rules.

According to an aspect of the present disclosure, based on one rule, the expression of the one rule may be vectorized with different dimensions. A cluster model may be built in which their distance is replaced by a specific vector distance. Multiple models may be formed based on different settings of the vector distance. In addition, there may be different criteria to filter or select some center vectors in different cluster models and combine the center vectors in different cluster models.

The embodiments of the present disclosure provide for an improvement in the operation of a computer-based on reduced processing power requirements and computer resources. In addition, in the field of data processing, there is an improvement resulting in a more efficient application of structured rules to the data, by reducing overlapping and sometimes completely redundant rules.

### Example Embodiment(s)

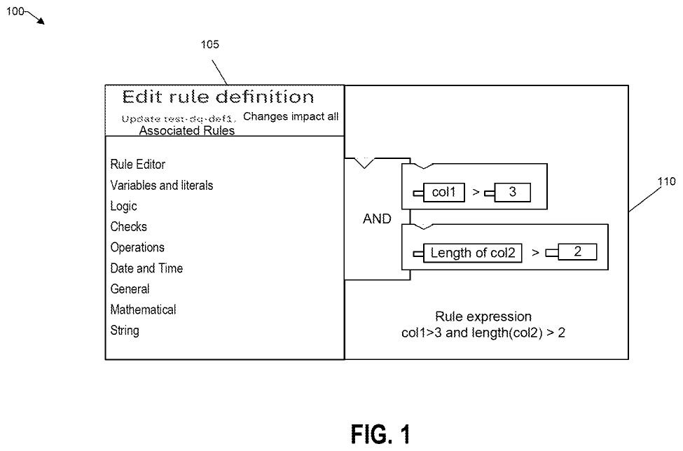

FIG. 1 is a screenshot 100 of a rule editor application, consistent with an illustrative embodiment. There is shown an edit rule definition menu 105 that includes a rule editor. The rule expression logic 110 is shown for the selected rule “test-dq-def1”. Rule expressions illustrate a relationship between sets of input data values and sets of result values. In the expression shown in FIG. 1, there is a “col1” and length of column parameters. In the rule expression, the column distance is greater than 3 and the column length is greater than 2.

The selected rule “test-dq-def1” is set with the variables of doors >3 and persons.

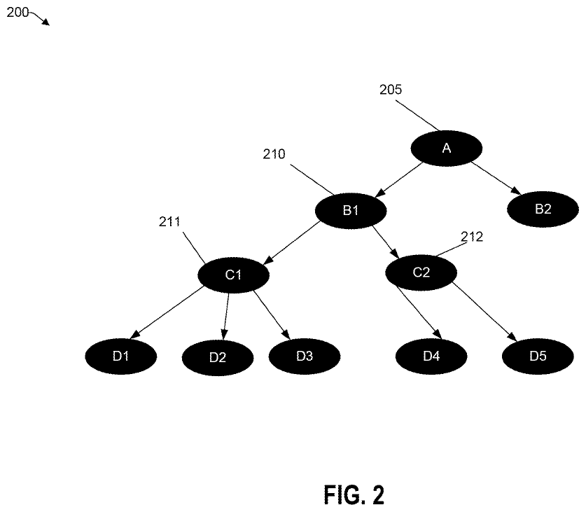

The expression rule expression “test-dq-def1” shown in FIG. 1 is used in this example. In one embodiment, for one expression that includes logic and a relationship, the relationship is first extracted. The relationship may include “and-or-not” conjunctions when there exist iterations of the relationship. In any event, the extraction is literal, and for each extracted object, it is defined as an element. Each iteration of the relationship is used to form one layer. Each of the layers will be used to form an “and-or-not” tree such as discussed with regard to FIG. 2.

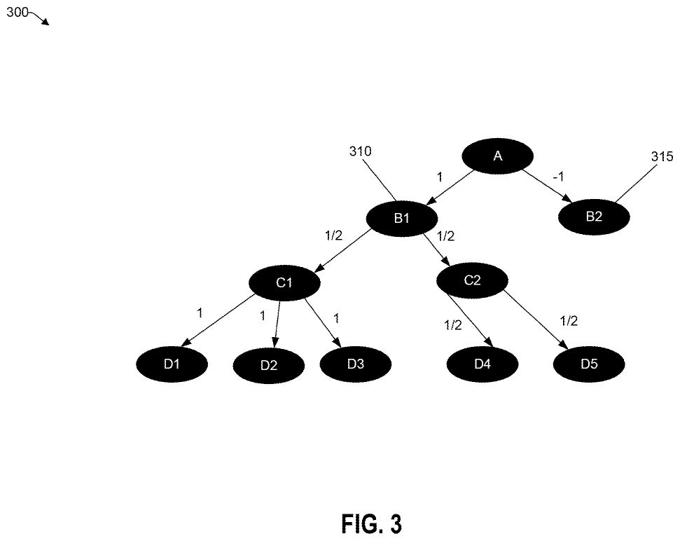

FIG. 2 illustrates a tree structure 200 in which an expression is vectorized based on one rule, consistent with an illustrative embodiment. The structured rules are vectorized to vector by tree-similarity related distance. The vectorized expression of the one rule is typically a first operation. More particularly, FIG. 2 shows the and-or-not tree 200 formed from the expression shown in FIG. 1. Each of the leaf nodes (B2, D1, D2, D3, D4, D5) in the and-or-not tree 200 is a representation of the basic expression, with the top or root node A 205. The intermediate nodes (B1 210, C1 211, C2 212) are a combination of the basic expression combined by and/or logic. From the upper layer to the lower layer there is a weight ranging from −1 to 1. As shown in FIG. 3 The weight from A1 to B1 310 is 1, and from A1 to B2 315 is −1.

For example, one rule is ((field1>2 and field 2 in [A,C] and field 3>8) or (field 1>8 or field 3<13) and not (field 1<0)) will be used to form one tree in which:

D1 is field 1>2, D2 is field 2 in [A,C], D3 is field 3>8, D4 is field 1>8,

D5 is field 3<13, B2 is field 1<0.

FIG. 3 illustrates a tree structure 300 with connected weights, consistent with an illustrative embodiment. With regard to the weight, a default can be used if the relationship is “and”, each weight connected is 1. If the relationship is “or”, the value may be 1/n, with n being the connected items by “or”. In FIG. 3, each node value should be normalized to [−1, 1].

For a continuous field, there is an upper boundary and a lower boundary, e.g., the field 1 range is [0,50], the D1 (field 1>2) value will be 1-2/(50-0)=0.96.

For a category field, e.g., the field 2 category is [A, B, C, D], the D2 (field 2 in [A, C]) value may be in order in all combinations/number of all combinations, so that:

(C¹₄+2)/(C¹₄+C²₄+C³₄+C⁴₄)=(4+2)/(4+6+4+1)=0.4.

Then the expression will be used to form one value for each node.

In a second operation, a cluster model is built on all the vectors having a distance that will be replaced by a specific vector distance. Based on the tree vector formed in the first operation, the distance of the vectors is calculated between each other (operation 2-1). Then, the distance from the last layer is calculated (operation 2-2). If the layer number is different, the distance calculation will start from the last layer number that is common to both trees. For example, in a case where there were two trees (V98 and V99), where V98 has 5 layers, and V99 has 3 layers, the distance calculation would start from the third layer.

In each compared layer, one vector is extracted from all fields (operation 2-3). For example, D1-D5 is related to V1-V5, which is the value on each node acquired in D171-5, the data contains three fields. One vector is formed V1*(1,0,0)+V2*(0,1,0)+V3*(0,0,1)+V4*(1,0,0)+V5*(0,0,1).

The upper layer vector will be calculated with a similar operation that additionally considers the weight (operation 2-4). Thus, one final vector may be formed to represent one tree as V. The distance between V1 (m layer) and V2 (n layer) are calculated, then an iteration of each layer is calculated using a square root summarized value as a distance between two trees.

Based on the distance, the cluster model is built similarly to a k-means clustering. It is to be understood that K-means clustering is one type of a machine learning algorithm, and the present disclosure is not limited to this form of clustering. Virtually any type of cluster algorithm using a distance concept may be selected to practice the methods disclosed herein.

In a K-means clustering, a distance between two vectors comes from a Euclidean distance. In this example, the cluster model is built using the distance formed in 2-4 as a replacement.

In a third operation, different models are formed based on different settings. For example, based on different cluster models with different start point/settings/weights, several cluster models may be built.

### Example Process

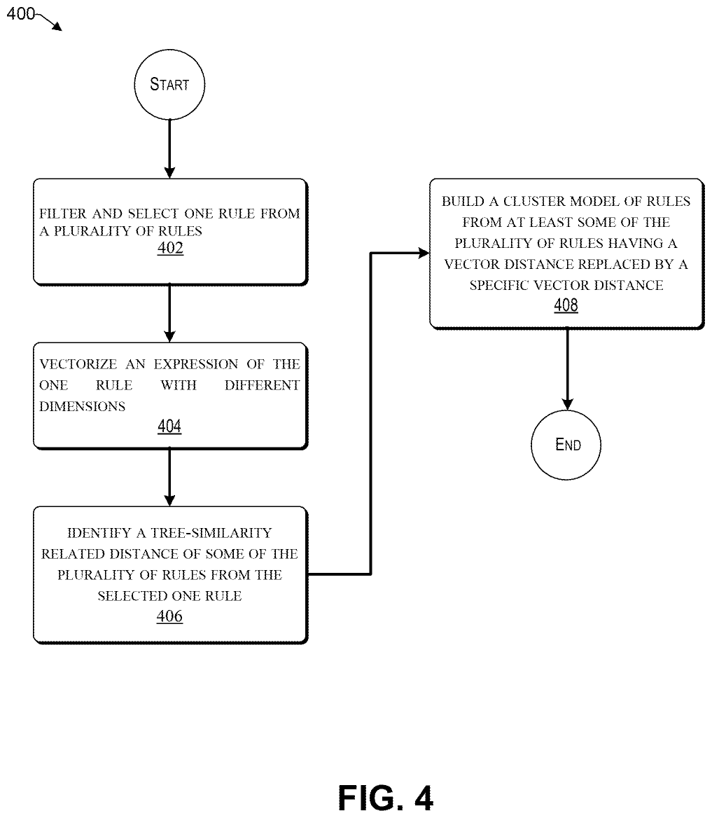

With the foregoing overview of the example architecture, it may be helpful now to consider a high-level discussion of an example process. To that end, FIG. 4 is a flowchart 400 illustrating a computer-implemented method of optimizing structured rules in data processing, consistent with an illustrated embodiment. FIG. 4 is shown as a collection of blocks, in a logical order, which represents a sequence of operations that can be implemented in a combination thereof.

The computer-implemented method begins with filtering and selecting one rule from a plurality of rules (operation 402) As discussed hereinabove, there may be thousands of rules to cover and pass data to find useful information, which cannot be performed by the human mind and necessarily requires a computing device. In a particular embodiment of the present disclosure, machine learning is used for the filtering and selecting of rules, as this is an iterative operation. The machine learning may be supervised or unsupervised. Redundancies and overlapping rules can be filtered so that the selected rule(s) provide for a more efficient data analysis to find useful information. The one rule that is selected may be used to replace a number of redundant or overlapping rules. It is noted that there is some tradeoff of faster processing versus accuracy by analyzing days with the selected rule(s) rather than most or all of the rules.

An expression of the selected one rule is vectorized with different dimensions (operation 404). FIG. 1 shows a rule editor definition screen with a diagram of the rule expression by column size and length. Based on vectorization and distance computation, key rules may be selected. With the selected rules, a similar result can be achieved versus the result of passing the data through all the rules, saving on computer resources, processing time, and energy. In an illustrative embodiment, machine learning models are used to filter and select the rules.

A tree-similarity related distance of some of the plurality of rules is identified from the selected one rule (operation 406). As shown in FIGS. 2 and 3, for one expression that has logic and relationship, the relationship (including and-or-not) when there is an iterative relationship is extracted. Based on the tree-similarity related distance, an and-or-not vector tree is formed. For example, each leaf node is the basic expression. There may be a weight from the upper layer to the lower layer (each iteration process forms one layer) from −1 to 1.

A cluster model of rules is built from at least some of the plurality of rules having a vector distance replaced by a specific vector distance (operation 408). Based on the and-or-not-vector tree formed in operation (406) the distance is calculated from each layer. In each compared layer, one vector is extracted from all fields. A final vector can be formed to present the tree as “V”. The distance is calculated between, for example, V1 (m layer) and V2 layer (n layer). Each layer is iterated and a square root (sqrt) summarized value is used as the distance between two trees. Based on the distance cluster models may be built similar to k means clustering, such as grid-based or density-based clustering. The data may be passed through the filtered and selected rule as constructed in operations 401 to 408 to extract information instead of analyzing all the rules. A more efficient result is obtained than when some or all the rules are applied with redundancies, sometimes complete and sometimes overlapping.

Based on different settings, multiple cluster models may be formed. For example, using different start points/settings/weights, different cluster models may be built. In the event that more than one data tree exists in a cluster despite changing start points and settings, it can be considered that the representation by the data trees is sufficiently similar. The user may be prompted with suggestions as to merge two rules or delete one rule as a way to overcome redundancy. Different types of cluster models may be built other than by k-means. For example,

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

### Example Computing Environment

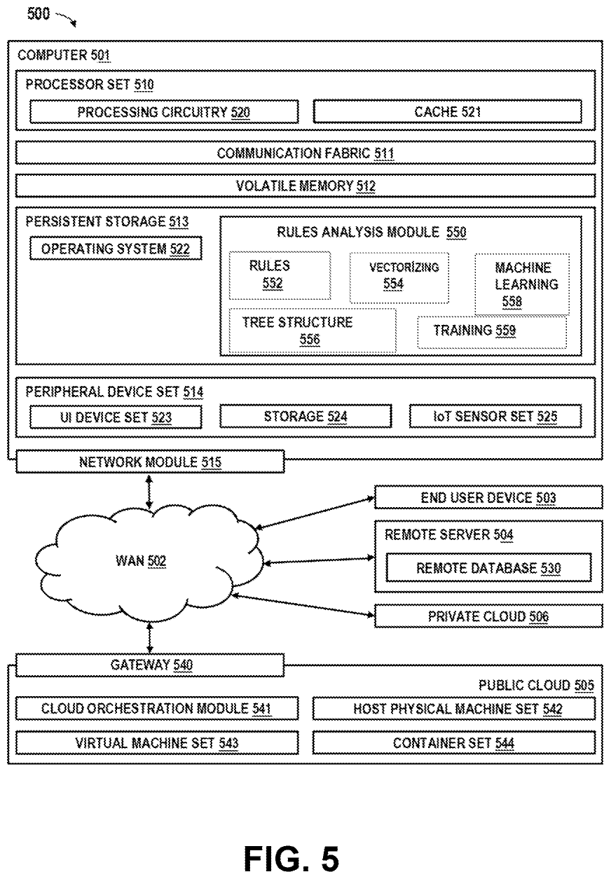

FIG. 5 illustrates a block diagram 500 of a particularly configured computing environment to optimize structured rules in data processing, consistent with an illustrative embodiment.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

With reference to FIG. 5, the computing environment 500 includes an example of an environment for the execution of at least some of the computer code involved in performing the inventive methods. In an embodiment, computer executable instructions in a rules analysis module 550 control operations of the rules module 552, vectorizing module 554, tree structure module 556, machine learning module 558, and training module 559. The rules module 552 filters and selects rules from a plurality of rules providing during a data processing operation to extract useful information. The vectoring module 554 performs a vectorization of the expression of the selected rule with different dimensions such as shown in FIG. 1. A rule editor application, such as shown in FIG. 1, including an edit rule definition menu, may be used to vectorize expressions based on column length and distance. The tree structure module 556 is used to create data trees in cluster modeling operations. The machine learning module 558 is used to assist in filtering and selecting specific rules from the plurality of rules. In some illustrative embodiments, the machine learning module assists in filtering and selecting specific rules for different purposes. For example, there may be different types of information sought to be extracted from data, and different rules may be filtered and selected with the aid of machine learning to achieve this purpose. The training data 559 may provide public and private data to train the machine learning module. The machine learning may be supervised or unsupervised.

In addition, computing environment 500 includes, for example, computer 501, wide area network 502 (WAN), end user device 503 (EUD), remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and die bond control module 550, as identified above), peripheral device set 514 (including user interface (UI) device set 523, storage 524, and Internet of Things (IoT) sensor set 525), and network module 565. Remote server 504 includes remote database 560. Public cloud 505 includes gateway 540, cloud orchestration module 541, host physical machine set 542, virtual machine set 543, and container set 544.

Computer 501 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically Computer 501, to keep the presentation as simple as possible. Computer 501 may be located in a cloud, even though it is not shown in a cloud in FIG. 5. On the other hand, Computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto Computer 501 to cause a series of operational steps to be performed by processor set 510 of Computer 501 and thereby effect a computer-implemented method, such that the instructions thus executed instantiates the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in persistent storage 513.

Communication fabric 511 is the signal conduction path that allows the various components of Computer 501 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, volatile memory 512 is characterized by random access, but this is not required unless affirmatively indicated. In Computer 501, the volatile memory 512 is located in a single package and is internal to Computer 501, but, alternatively or additionally, the volatile memory may be distributed over multiple packages and/or located externally with respect to Computer 501.

Persistent storage 513 is any form of non-volatile storage for computers that is now known or to be developed in the future. The non-volatility of this storage means that the stored data is maintained regardless of whether power is being supplied to Computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface-type operating systems that employ a kernel. The code included in the persistent storage 513 typically includes at least some of the computer code involved in performing the inventive methods.

Peripheral device set 514 includes the set of peripheral devices of Computer 501. Data communication connections between the peripheral devices and the other components of Computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where Computer 501 is required to have a large amount of storage (for example, where Computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows Computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to Computer 601 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 503 is any computer system that is used and controlled by an end user (for example, a customer of an enterprise that operates Computer 501) and may take any of the forms discussed above in connection with Computer 501. EUD 503 typically receives helpful and useful data from the operations of Computer 501. For example, in a hypothetical case where Computer 501 is designed to provide a recommendation to an end user, this recommendation would typically be communicated from network module 515 of Computer 501 through WAN 502 to EUD 503. In this way, EUD 503 can display, or otherwise present, the recommendation to an end user. In some embodiments, EUD 503 may be a client device, such as a thin client, heavy client, mainframe computer, desktop computer and so on.

Remote server 504 is any computer system that serves at least some data and/or functionality to Computer 501. Remote server 504 may be controlled and used by the same entity that operates Computer 501. Remote server 504 represents the machine(s) that collect and store helpful and useful data for use by other computers, such as Computer 501. For example, in a hypothetical case where Computer 501 is designed and programmed to provide a recommendation based on historical data, then this historical data may be provided to Computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to better explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method of optimizing structured rules in data processing, the method comprising:
filtering and selecting one rule from a plurality of rules;
vectorizing an expression of the one rule with different dimensions; and
building a cluster model of rules from at least some of the plurality of rules having a vector distance replaced by a specific vector distance;
wherein the building of the cluster model of rules is based on identifying a tree-similarity related distance of some of the plurality of rules from the selected one rule.

2. The computer-implemented method according to claim 1, wherein the filtering and selecting of the one rule is performed using machine learning.

3. The computer-implemented method according to claim 2, wherein the machine learning filters and selects specific rules from the plurality of rules based on an identified purpose.

4. The computer-implemented method according to claim 2, wherein vectorizing an expression of the one rule includes forming an and-or-not tree from the expression.

5. The computer-implemented method according to claim 2, further comprising building at least another cluster model of rules based on a different setting of the specific vector distance; and
wherein when the building of the cluster model of rules includes forming more than one and-or-not tree, the specific distance is set by performing a distance calculation starting from a last layer number that is common to each and-or-not tree.

6. The computer-implemented method according to claim 5, further comprising selecting center vectors of one or more cluster models of rules is performed according to predetermined criteria.

7. The computer-implemented method according to claim 5, further comprising filtering and selecting center vectors of one or more cluster models of rules and combining the center vectors in different cluster models.

8. The computer-implemented method according to claim 2, wherein the building of the clustering model of rules is performed using a k-means clustering operation.

9. The computer-implemented method according to claim 2, wherein the building of the clustering model of rules is performed using a density-based clustering operation.

10. The computer-implemented method according to claim 2, wherein the building of the clustering model of rules is performed using a grid-based clustering operation.

11. The computer-implemented method according to claim 2, further comprising building a plurality of cluster models of rules from at least some of the plurality of rules.

12. The computer-implemented method according to claim 2, further comprising combining two or more cluster models of rules.

13. A computing device configured to optimize structured rules in data processing, the computing device comprising:
a processor;
a storage device coupled to the processor, the storage device storing instructions to cause the processor to perform acts comprising:
filtering and selecting one rule from a plurality of rules;
vectorizing an expression of the one rule with different dimensions; and
building a cluster model of rules from at least some of the plurality of rules having a vector distance replaced by a specific vector distance,
wherein the building of the cluster model of rules is based on identifying a tree-similarity related distance of some of the plurality of rules from the selected one rule.

14. The computing device according to claim 13, wherein the instructions cause the processor to perform an additional act comprising using machine learning to perform the filtering and selecting of the one rule.

15. The computing device according to claim 14, wherein the instructions cause the processor to perform an additional act comprising building the clustering model of rules by using a k-means clustering operation.

16. The computing device according to claim 14, wherein the instructions cause the processor to perform an additional act comprising using a density-based clustering operation.

17. The computing device according to claim 14, wherein the instructions cause the processor to perform an additional act comprising building a plurality of cluster models of rules from at least some of the plurality of rules.

18. The computing device according to claim 14, wherein the instructions cause the processor to perform additional acts comprising building at least another cluster model of rules based on a different setting of the specific vector distance.

19. The device according to claim 18, wherein the instructions cause the processor to perform additional acts comprising filtering and selecting center vectors of one or more cluster models of rules and combining the center vectors in different cluster models.

20. The computing device according to claim 14, wherein the instructions cause the processor to perform additional acts comprising combining two or more cluster models of rules.
